(19) United States
(12) Patent Application Publication
(10) Pub. No.: US 2025/0183292 A1
(43) Pub. Date: Jun. 5, 2025

(54) NON-AQUEOUS ELECTROLYTE SECONDARY BATTERY

(71) Applicant: Prime Planet Energy & Solutions, Inc., Tokyo (JP)

(72) Inventor: Hikaru YOSHIDA, Ibaraki-shi (JP)

(21) Appl. No.: 18/967,650

(22) Filed: Dec. 4, 2024

(30) Foreign Application Priority Data
Dec. 5, 2023 (JP) 2023-205111

(51) Int. Cl. H01M 4/525; H01M 4/02; H01M 4/587

(52) U.S. Cl. CPC H01M 4/525; H01M 4/587; H01M 2004/027

(57) ABSTRACT

The present disclosure provides a non-aqueous electrolyte secondary battery, wherein a positive electrode active material layer includes a positive electrode active material represented by a formula (1), Li₍₁₊ₓ₎Ni_{y}Ti_{z}Me_{(1-y-z)}O₂, and when a specific surface area of a negative electrode active material layer is represented by S (m²/g), a relational formula (a), 10x+2<S, is satisfied. According to the present disclosure, there is provided a non-aqueous electrolyte secondary battery in which an initial cycle capacity retention is high and a decrease in cycle capacity retention is suppressed after a storage durability test.

### CROSS REFERENCE TO RELATED APPLICATIONS

This nonprovisional application is based on Japanese Patent Application No. 2023-205111 filed on Dec. 5, 2023 with the Japan Patent Office, the entire contents of which are hereby incorporated by reference.

### BACKGROUND OF THE INVENTION

### Field of the Invention

The present disclosure relates to a non-aqueous electrolyte secondary battery.

### Description of the Background Art

Japanese Patent Laying-Open No. 2011-113825 proposes a positive electrode material having a high nickel content and used for a lithium-ion secondary battery.

### SUMMARY OF THE INVENTION

When a lithium composite oxide having a high nickel content is used for a positive electrode active material layer, a non-aqueous electrolyte secondary battery (hereinafter also referred to as “battery”) can have a high capacity; however, a side reaction in each of a negative electrode and a positive electrode as well as capacity deterioration in the positive electrode active material tend to be likely to occur in a storage durability test. Due to the side reaction, each of capacity-potential curves (hereinafter also referred to as “positive electrode single-electrode curve” and “negative electrode single-electrode curve”) in the positive electrode and the negative electrode may be shifted (FIGS. 1, 2, and 3). When the sum of a shift amount (hereinafter also referred to as “positive electrode shift amount”) of the positive electrode single-electrode curve and the capacity deterioration in the positive electrode active material becomes larger than a shift amount (hereinafter also referred to as “negative electrode shift amount”) of the negative electrode single-electrode curve, a reserve capacity of the negative electrode is decreased, with the result that lithium (Li) is precipitated on the negative electrode and a cycle capacity retention tends to be likely to be decreased.

An object of the present disclosure is to provide a non-aqueous electrolyte secondary battery in which an initial cycle capacity retention is high and a decrease in cycle capacity retention is suppressed after a storage durability test.

The present disclosure provides the following non-aqueous electrolyte secondary battery.

[1] A non-aqueous electrolyte secondary battery comprising an electrode assembly, wherein
the electrode assembly includes a positive electrode plate and a negative electrode plate,
the positive electrode plate includes a positive electrode active material layer,
the negative electrode plate includes a negative electrode active material layer,
the positive electrode active material layer includes a positive electrode active material represented by the following formula (1):

Li₍₁₊ₓ₎Ni_{y}Ti_{z}Me_{(1-y-z)}O₂, where
Me includes two or more selected from a group consisting of Mn, Co and Al, and
relations of 0<x<0.1, 0.8<y<0.85 and 0≤z<0.03 are satisfied,
the negative electrode active material layer includes an negative electrode active material,
the negative electrode active material includes graphite, and
when a specific surface area of the negative electrode active material layer is represented by S (m²/g), the following relational formula is satisfied:

$$10 x + 2 < S . \qquad ( a )$$

[2] The non-aqueous electrolyte secondary battery according to [1], wherein (b) S<10x+3.4 is further satisfied.

[3] The non-aqueous electrolyte secondary battery according to [1] or [2], wherein a graphite content in the negative electrode active material is 99 mass % or more.

[4] The non-aqueous electrolyte secondary battery according to any one of [1] to [3], wherein a relation of 0.01<z<0.03 is satisfied in the formula (1).

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic diagram for illustrating a positive electrode single-electrode curve, a negative electrode single-electrode curve, a cell capacity, and a reserve capacity.

FIG. 2 is a schematic diagram for illustrating a negative electrode shift.

FIG. 3 is a schematic diagram for illustrating a positive electrode shift.

FIG. 4 is a schematic diagram showing an exemplary configuration of a battery according to the present embodiment.

FIG. 5 is a schematic diagram showing an exemplary configuration of an electrode assembly according to the present embodiment.

FIG. 6 is a graph for illustrating a relation between a reserve capacity of a negative electrode and a cycle capacity retention.

FIG. 7 is a graph for illustrating a relation between a specific surface area of a negative electrode active material layer and an irreversible amount of Li of the negative electrode due to a storage durability test.

FIG. 8 is a graph for illustrating a relation between a composition of the positive electrode active material layer and the positive electrode shift amount.

FIG. 9 is a graph for illustrating a relation between the composition of the positive electrode active material layer and the specific surface area of the negative electrode active material layer with regard to the cycle capacity retention after the storage durability test.

FIG. 10 is a graph for illustrating a relation between the composition of the positive electrode active material layer and the specific surface area of the negative electrode active material layer with regard to a capacity retention after the storage durability test.

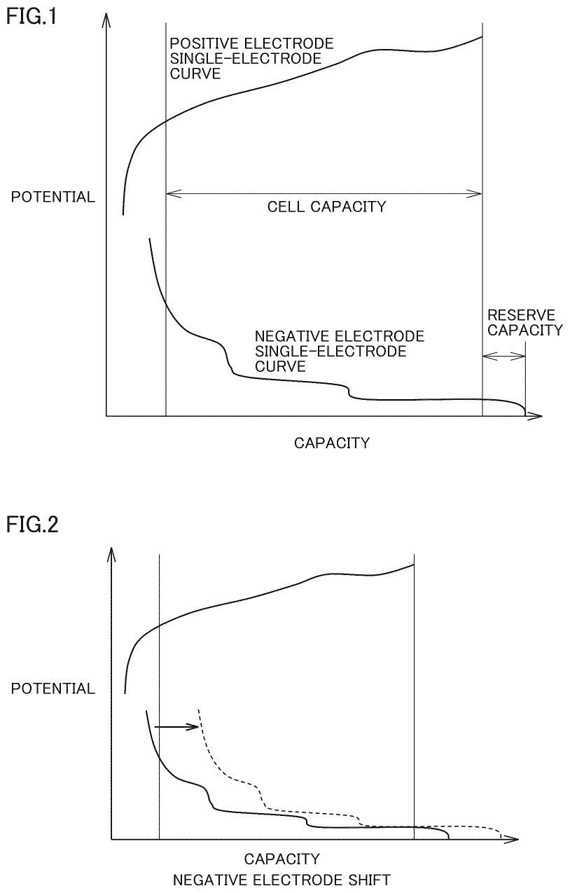

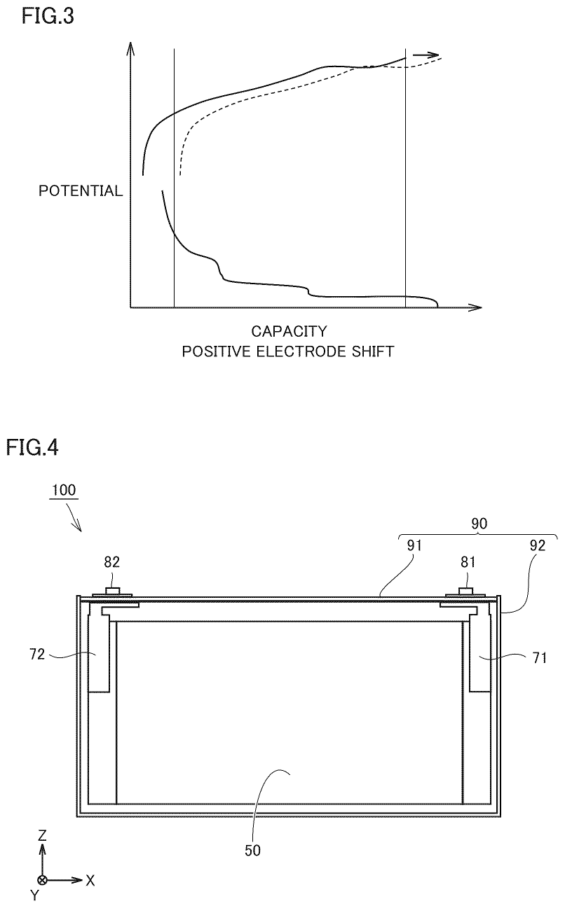

### DESCRIPTION OF THE PREFERRED EMBODIMENTS

Hereinafter, embodiments of the present invention will be described with reference to figures, but the present invention is not limited to the below-described embodiments. In each of all the figures described below, a scale is appropriately adjusted to facilitate understanding of each component, and the scale of each component shown in the figures does not necessarily coincide with the actual scale of the component. In the below-mentioned description of each of the embodiments, the same or corresponding portions are denoted by the same reference characters and will not be described repeatedly.

### <Non-Aqueous Electrolyte Secondary Battery>

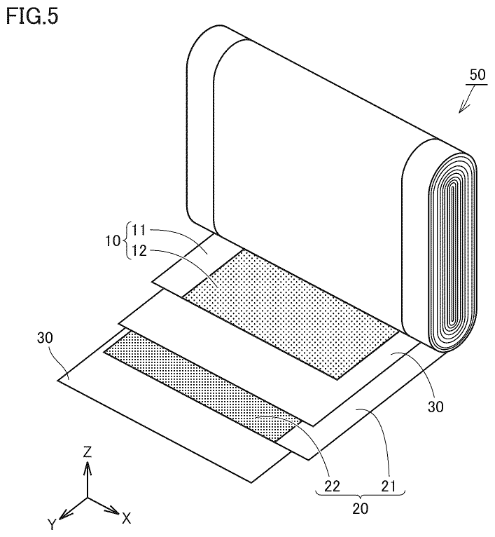

FIG. 4 is a schematic diagram showing an exemplary configuration of a battery according to the present embodiment.

A battery 100 may be used in any application. Battery 100 may be used as a main electric power supply or a motive power assisting electric power supply in an electrically powered vehicle or the like, for example. A battery module or a battery assembly may be formed by connecting a plurality of batteries 100.

Battery 100 includes an exterior package 90. Exterior package 90 has a prismatic shape (flat rectangular parallelepiped shape). It should be noted that the prismatic shape is exemplary. Exterior package 90 may have any shape. Exterior package 90 may have, for example, a cylindrical shape or a pouch shape. Exterior package 90 may be composed of, for example, an Al alloy. Exterior package 90 accommodates an electrode assembly 50 and an electrolyte solution (not shown). Exterior package 90 may include, for example, a sealing plate 91 and an exterior container 92. Sealing plate 91 closes an opening of exterior container 92. For example, sealing plate 91 and exterior container 92 may be joined to each other by laser welding.

A positive electrode terminal 81 and a negative electrode terminal 82 are provided on sealing plate 91. Sealing plate 91 may be further provided with an injection opening and a gas-discharge valve. The electrolyte solution can be injected from the injection opening to inside of exterior package 90. Electrode assembly 50 is connected to positive electrode terminal 81 by a positive electrode current collecting member 71. Positive electrode current collecting member 71 may be, for example, an Al plate or the like. Electrode assembly 50 is connected to negative electrode terminal 82 by a negative electrode current collecting member 72. Negative electrode current collecting member 72 may be, for example, a Cu plate or the like.

FIG. 5 is a schematic diagram showing an exemplary configuration of the electrode assembly according to the present embodiment. Electrode assembly 50 is a wound type. Electrode assembly 50 includes a positive electrode plate 10, a separator 30, and a negative electrode plate 20. That is, battery 100 includes positive electrode plate 10, negative electrode plate 20, and the electrolyte solution. Each of positive electrode plate 10, separator 30, and negative electrode plate 20 is a sheet in the form of a strip. Electrode assembly 50 may include a plurality of separators 30. Electrode assembly 50 is formed by stacking positive electrode plate 10, separator 30, and negative electrode plate 20 in this order and winding them in the form of a spiral. One of positive electrode plate 10 or negative electrode plate 20 may be interposed between separators 30. Each of positive electrode plate 10 and negative electrode plate 20 may be interposed between separators 30. Electrode assembly 50 may be shaped to have a flat shape after the winding. It should be noted that the wound type is exemplary.

Electrode assembly 50 may be, for example, a stacked type.

### (Positive Electrode Plate)

Positive electrode plate 10 includes a positive electrode substrate 11 and a positive electrode active material layer 12. Positive electrode substrate 11 is an electrically conductive sheet. Positive electrode substrate 11 may be, for example, an Al alloy foil or the like. Positive electrode substrate 11 may have a thickness of, for example, 10 μm to 30 μm. Positive electrode active material layer 12 is disposed on a surface of positive electrode substrate 11. Positive electrode active material layer 12 may be disposed only on one surface of positive electrode substrate 11, for example. Positive electrode active material layer 12 may be disposed on each of the front and rear surfaces of positive electrode substrate 11, for example. Positive electrode substrate 11 may be exposed at one end portion in the width direction of positive electrode plate 10 (X axis direction in FIG. 5). Positive electrode current collecting member 71 can be joined to the exposed portion of positive electrode substrate 11.

For example, an intermediate layer (not shown) may be formed between positive electrode active material layer 12 and positive electrode substrate 11. In the present embodiment, also when the intermediate layer is present, positive electrode active material layer 12 is regarded as being disposed on the surface of positive electrode substrate 11. The intermediate layer may be thinner than positive electrode active material layer 12. The intermediate layer may have a thickness of 0.1 μm to 10 μm, for example. The intermediate layer may include, for example, a conductive material, an insulating material, or the like.

### (Positive Electrode Active Material Layer)

Positive electrode active material layer 12 includes a positive electrode active material. The positive electrode active material includes a lamellar metal oxide represented by the following formula (1):

Li₍₁₊ₓ₎Ni_{y}Ti_{z}Me_{(1-y-z)}O₂, where
Me includes two or more selected from a group consisting of Mn, Co and Al, and
relations of 0<x<0.1, 0.8<y<0.85, and 0≤z<0.03 are satisfied.

The lamellar metal oxide represented by the formula (1) may satisfy relations of 0<x<0.2, 0.8<y<0.84, and 0.01<z<0.03, for example.

The lamellar metal oxide represented by the formula (1) may include at least one selected from a group consisting of Zr, B, Mg, Fe, Cu, Zn, Sn, Na, K, Ba, Sr, Ca, W, Mo, Nb, Si, V, Cr, and Ge.

The positive electrode active material is a particle group. The particle group can include a first positive electrode active material particle group and a second positive electrode active material particle group. The first positive electrode active material particle group consists of a plurality of first positive electrode active material particles. The second positive electrode active material particle group consists of a plurality of second positive electrode active material particles. Each of the first positive electrode active material particles and the second positive electrode active material particles can have any shape. Each of the first positive electrode active material particle and the second positive electrode active material particle may have a spherical shape, a columnar shape, a lump-like shape, or the like, for example.

The plurality of first positive electrode active material particles may have an average particle size (D50) of, for example, 10 μm to 20 μm. The plurality of second positive electrode active material particles may have an average particle size (D50) of, for example, 0.5 μm to 9 μm. In the present specification, the average particle size (D50) is defined as a particle size corresponding to a cumulative frequency of 50% from the smallest particle size in a volume-based particle size distribution. The volume-based particle size distribution can be measured by a laser diffraction type particle size distribution measurement apparatus.

Each of the first positive electrode active material particles and the second positive electrode active material particles independently includes the positive electrode active material represented by the formula (1). Each of the first positive electrode active material particle and the second positive electrode active material particle can independently have any crystal structure. Each of the first positive electrode active material particle and the second positive electrode active material particle may independently have a lamellar structure, a spinel structure, an olivine structure, or the like, for example. Each of the first positive electrode active material particle and the second positive electrode active material particle may have substantially the same chemical composition. The first positive electrode active material particle and the second positive electrode active material particle may have chemical compositions different from each other.

Positive electrode active material layer 12 may further include an additional component as long as the positive electrode active material is included. Positive electrode active material layer 12 may include, for example, a conductive material, a binder, or the like in addition to the positive electrode active material. The conductive material can include any component. For example, the conductive material may include at least one selected from a group consisting of carbon black, graphite, vapor-grown carbon fiber (VGCF), carbon nanotube (CNT), and graphene flake. A blending amount of the conductive material may be, for example, 0.1 part by mass to 10 parts by mass with respect to 100 parts by mass of the positive electrode active material. The binder can include any component. For example, the binder may include at least one selected from a group consisting of polyvinylidene difluoride (PVdF), poly(vinylidene fluoride-co-hexafluoropropylene) (PVdF-HFP), polytetrafluoroethylene (PTFE), and polyacrylic acid (PAA). A blending amount of the binder may be, for example, 0.1 part by mass to 10 parts by mass with respect to 100 parts by mass of the positive electrode active material. Positive electrode active material layer 12 may include 80% to 99% of the positive electrode active material in mass fraction, 0.1% to 10% of the conductive material in mass fraction, and a remainder of the binder, for example.

Positive electrode active material layer 12 may have a thickness of, for example, 10 μm to 200 μm. Positive electrode active material layer 12 may have a thickness of, for example, 50 μm to 150 μm. Positive electrode active material layer 12 may have a thickness of, for example, 50 μm to 100 μm.

Positive electrode active material layer 12 can have a high density. Positive electrode active material layer 12 may have a density of 3.3 g/cm³ to 3.9 g/cm³, for example. Positive electrode active material layer 12 may have a density of 3.4 g/cm³ to 3.7 g/cm³, for example. Positive electrode active material layer 12 may have a density of 3.4 g/cm³ to 3.6 g/cm³, for example. The density of the active material layer in the present specification represents an apparent density.

Positive electrode plate 10 is manufactured in the following manner: positive electrode active material layer 12 is formed by applying a positive electrode slurry to a surface of positive electrode substrate 11, positive electrode active material layer 12 and positive electrode substrate 11 are subjected to rolling to manufacture a raw sheet, and then the raw sheet is cut into a predetermined planar size in accordance with the specification of battery 100. The positive electrode slurry is prepared by mixing the positive electrode active material and the additional component.

### (Negative Electrode Plate)

Negative electrode plate 20 may include a negative electrode substrate 21 and a negative electrode active material layer 22, for example. Negative electrode substrate 21 is an electrically conductive sheet. Negative electrode substrate 21 may be, for example, a Cu alloy foil or the like. Negative electrode substrate 21 may have a thickness of, for example, 5 μm to 30 μm. Negative electrode active material layer 22 may be disposed on a surface of negative electrode substrate 21. Negative electrode active material layer 22 may be disposed only on one surface of negative electrode substrate 21, for example. Negative electrode active material layer 22 may be disposed on each of the front and rear surfaces of negative electrode substrate 21, for example. Negative electrode substrate 21 may be exposed at one end portion in the width direction of negative electrode plate 20 (X axis direction in FIG. 5). Negative electrode current collecting member 72 can be joined to the exposed portion of negative electrode substrate 21.

### (Negative Electrode Active Material Layer)

Negative electrode active material layer 22 includes a negative electrode active material. The negative electrode active material may include any component. The negative electrode active material may include, for example, at least one selected from a group consisting of graphite, soft carbon, hard carbon, silicon, silicon oxide, a silicon-based alloy, tin, tin oxide, a tin-based alloy, and lithium-titanium composite oxide. The graphite may be natural graphite or may be artificial graphite.

Negative electrode active material layer 22 may further include, for example, a binder or the like as the other component in addition to the negative electrode active material. For example, negative electrode active material layer 22 may include: 95% to 99.5% of the negative electrode active material in mass fraction; and the remainder of the binder. The binder can include any component. The binder may include, for example, at least one selected from a group consisting of carboxymethyl cellulose (CMC) and styrene-butadiene rubber (SBR). When negative electrode active material layer 22 includes graphite, a graphite content in the negative electrode active material is preferably 99 mass % or more. The specific surface area of the negative electrode active material may be, for example, 0.5 to 5 m²/g.

The specific surface area of negative electrode active material layer 22 may be, for example, 2 or more, may be 2 or more and 4.5 or less, and may be 2 or more and 4 or less. Specific surface area S of negative electrode active material layer 22 is a specific surface area of the negative electrode active material layer of the negative electrode plate removed from the battery after activation. Specific surface area S of negative electrode active material layer 22 is measured in accordance with a method described in the below-described section of Examples.

Negative electrode active material layer 22 may have a thickness of, for example, 10 μm to 200 μm.

Negative electrode active material layer 22 can have a high density. Negative electrode active material layer 22 may have a density of, for example, 1.0 g/cm³ to 2.0 g/cm³. Negative electrode active material layer 22 may have a density of, for example, 1.2 g/cm³ to 1.7 g/cm³. Negative electrode active material layer 22 may have a density of, for example, 1.3 g/cm³ to 1.6 g/cm³.

Negative electrode plate 20 is manufactured in the following manner: negative electrode active material layer 22 is formed by applying a negative electrode slurry to a surface of negative electrode substrate 21, negative electrode active material layer 22 and negative electrode substrate 21 are subjected to rolling to manufacture an raw sheet, and then the raw sheet is cut into a predetermined planar size in accordance with the specification of battery 100. The negative electrode slurry is prepared by mixing the negative electrode active material and the other component.

[Relational Formula (a)]

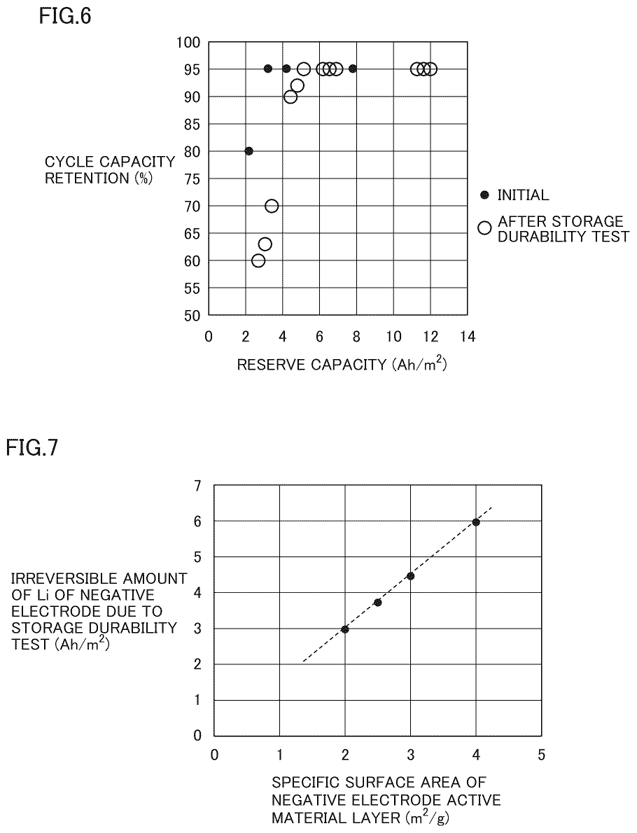

It has been found that the cycle capacity retention is correlated with the reserve capacity of the negative electrode (FIG. 6). When the sum of a positive electrode shift amount y1 (Ah/m²) and a capacity deterioration amount (Ah/m²) of the positive electrode active material becomes larger than a negative electrode shift amount y2 (Ah/m²), the reserve capacity (Ah/m²) of the negative electrode tends to be likely to be decreased.

Negative electrode shift amount y2 tends to be smaller as an irreversible amount of Li in the negative electrode is smaller, and the irreversible amount of Li in the negative electrode tends to be likely to depend on the specific surface area of the negative electrode active material layer (FIG. 7).

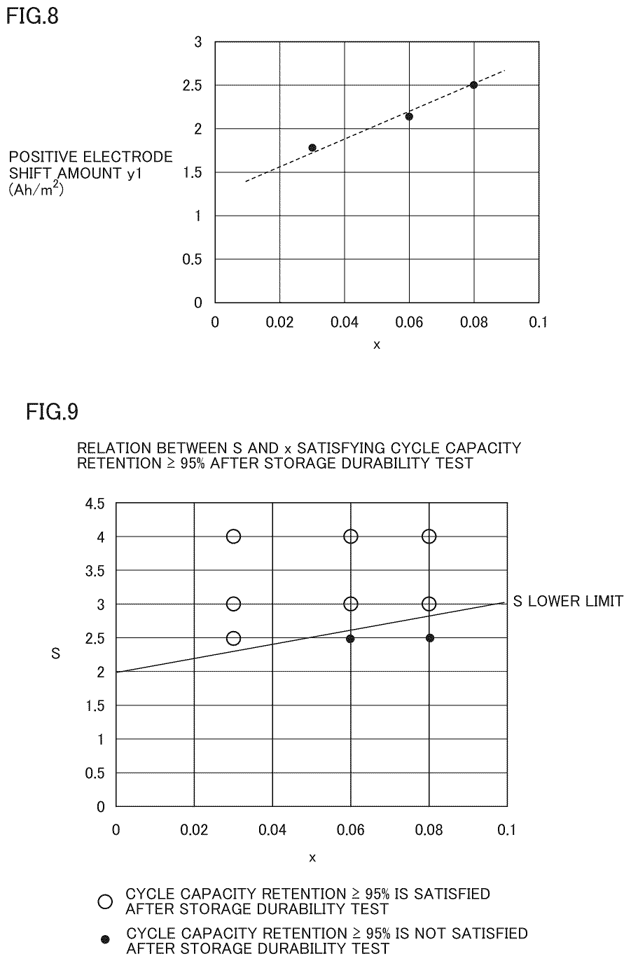

On the other hand, as a result of research by the present inventors, it has been found that positive electrode shift amount y1 is strongly correlated with a Li/M (=1+x) ratio in the positive electrode active material (M is the sum of metals other than Li in the positive electrode active material) (FIG. 8). Therefore, as a result of reviewing control of the specific surface area of the negative electrode active material layer in accordance with the Li/M ratio of the positive electrode active material, it has been found that when the specific surface area of negative electrode active material layer 22 is represented by S, the initial cycle capacity retention can be high and the decrease in the cycle capacity retention in the durability test can be suppressed by satisfying the following relational formula (a): 10x+2<S.

The relational formula (a) was found in the following manner: an x-S straight line is found from an approximate straight line (FIG. 7) obtained when plotting the irreversible amount of Li of the negative electrode due to the storage durability test with respect to the specific surface area of the negative electrode active material layer and an approximate straight line (FIG. 8) obtained when plotting positive electrode shift amount y1 with respect to x so as to at least satisfy a relation of positive electrode shift amount y1<negative electrode shift amount y2, and the x-S straight line is applied to suppress a decrease in cycle capacity retention (the cycle capacity retention ≥95% is satisfied) (FIG. 9). In the relational formula (a), the definition in the above-described formula (1) is applied to x. Specific surface area S of negative electrode active material layer 22 is measured in accordance with a method described in the below-described section of Examples.

[Relational Formula (b)]

The battery can further satisfy the following relational formula:

$$S < 10 x + 3.4 . \qquad ( b )$$

It has been found that when the battery satisfies the relational formula (b), precipitation of lithium is suppressed after the durability test, with the result that the decrease in capacity retention in the storage durability test is likely to be suppressed. When the battery satisfies the relational formulas (a) and (b), the decrease in cycle capacity retention is suppressed even after the durability test, and the decrease in the capacity retention in the durability test tends to be likely to be suppressed.

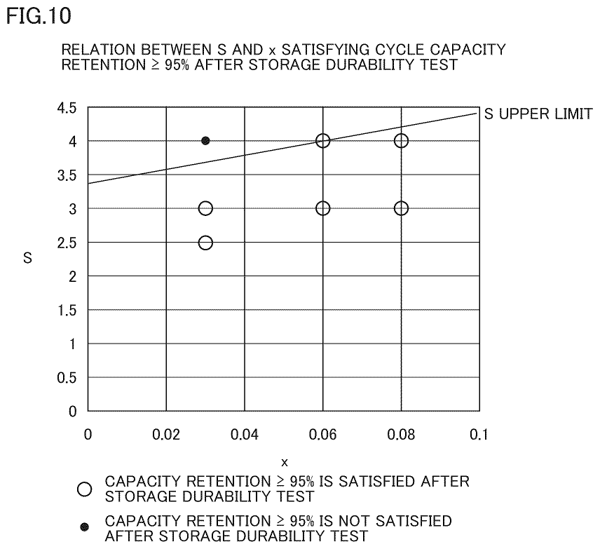

The relational formula (b) was found by applying the x-S straight line obtained as described above so as to suppress the decrease in capacity retention in the storage durability test (the capacity retention after 120 days ≥95% is satisfied) (FIG. 10).

### (Facing Capacity Ratio)

A facing capacity ratio (a ratio of the negative electrode capacity to the positive electrode capacity) may be, for example, 1.00 to 1.15, and is preferably 1.04 to 1.10. The negative electrode capacity is calculated by multiplying the total mass of the negative electrode active material included in negative electrode active material layer 22 by the specific capacity of the negative electrode active material. The positive electrode capacity is calculated by multiplying the total mass of the positive electrode active material included in positive electrode active material layer 12 by the specific capacity of the positive electrode active material.

### (Separator)

At least a portion of separator 30 is interposed between positive electrode plate 10 and negative electrode plate 20. Separator 30 separates positive electrode plate 10 and negative electrode plate 20 from each other. Separator 30 may have a thickness of, for example, 10 μm to 30 μm. Separator 30 is a porous sheet. Separator 30 permits the electrolyte solution to pass therethrough. Separator 30 may have an air permeability of, for example, 100 s/100 mL to 400 s/100 mL. In the present specification, the “air permeability” represents “Air Resistance” defined in “JIS P 8117:2009”. The air permeability is measured by the Gurley test method.

Separator 30 is electrically insulative. Separator 30 may include, for example, a polyolefin-based resin or the like. Separator 30 may consist essentially of a polyolefin-based resin, for example. The polyolefin-based resin may include at least one selected from a group consisting of polyethylene (PE) and polypropylene (PP), for example. Separator 30 may have a single-layer structure, for example. Separator 30 may consist essentially of a PE layer, for example. Separator 30 may have a multilayer structure, for example. Separator 30 may be formed by stacking a PP layer, a PE layer, and a PP layer in this order, for example. A heat-resistant layer or the like may be formed on the surface of separator 30, for example.

### (Electrolyte Solution)

The electrolyte solution includes a solvent and a supporting electrolyte. The solvent is aprotic. The solvent can include any component. The solvent may include, for example, at least one selected from a group consisting of ethylene carbonate (EC), propylene carbonate (PC), butylene carbonate (BC), dimethyl carbonate (DMC), ethyl methyl carbonate (EMC), diethyl carbonate (DEC), 1,2-dimethoxyethane (DME), methyl formate (MF), methyl acetate (MA), methyl propionate (MP), and γ-butyrolactone (GBL).

The supporting electrolyte is dissolved in the solvent. For example, the supporting electrolyte may include at least one selected from a group consisting of LiPF₆, LiBF₄, and LiN(FSO₂)₂. The supporting electrolyte may have a molar concentration of, for example, 0.5 mol/L to 2.0 mol/L. The supporting electrolyte may have a molar concentration of, for example, 0.8 mol/L to 1.2 mol/L.

The electrolyte solution may further include any additive. For example, the electrolyte solution may include the additive having a mass fraction of 0.01% to 5%. The additive may include, for example, at least one selected from a group consisting of vinylene carbonate (VC), lithium difluorophosphate (LiPO₂F₂), lithium fluorosulfonate (FSO₃Li), and lithium bis(oxalato) borate (LiBOB).

### <Method of Manufacturing Battery>

A method of manufacturing the battery according to the present embodiment includes: a step (A) of inserting the electrode assembly into the exterior package; a step (B) of injecting the electrolyte solution; and a step (C) of performing activation.

In the step (A) of inserting the electrode assembly into the exterior package, electrode assembly 50 is accommodated in exterior package 90. Electrode assembly 50 can be connected to positive electrode terminal 81 by positive electrode current collecting member 71. Electrode assembly 50 can be connected to negative electrode terminal 82 by, for example, negative electrode current collecting member 72. In the step (B) of injecting the electrolyte solution, the electrolyte solution is injected into exterior package 90. Electrode assembly 50 is impregnated with the electrolyte solution. After the electrolyte solution is injected, exterior package 90 is sealed.

In the step (C) of performing activation, battery 100 is activated. For example, battery 100 is charged in accordance with a constant current-constant voltage (CC-CV) method, and is discharged in accordance with a constant current (CC) method after passage of a predetermined time. More specifically, under a temperature environment of 25° C., charging is performed with a current of 0.2 mA/cm² in accordance with the constant current method until the positive electrode potential reaches 4.30 V (vs. Li⁺/Li), and then charging is performed in accordance with the constant voltage method until the current reaches 0.04 mA/cm². After 10 minutes of rest, discharging is performed with a current of 0.2 mA/cm² in accordance with the constant current method until the positive electrode potential reaches 2.5 V (vs. Li⁺/Li).

In this way, battery 100 is manufactured. Since battery 100 thus manufactured satisfies the relational formulas (a) and (b) as described above, the internal resistance is suppressed from being increased and an excellent melting/disconnection property is attained therein.

The battery can have a cycle capacity retention of 95% or more. Further, the battery can have a cycle capacity retention of 95% or more even after the storage durability test. When the cycle capacity retention is 95% or more even after the storage durability test, the battery can have excellent cycling performance. Further, the battery can have a capacity retention of 95% or more after the storage durability test of 120 days. When the capacity retention is 95% or more even after the storage durability test of 120 days, the battery can have an excellent storage durability characteristic.

Hereinafter, examples of the present technology will be described. However, the scope of the present technology is not restricted by the following description.

### EXAMPLES

### Example 1

### (Manufacturing of Positive Electrode Plate)

Large particles and small particles both composed of a lithium-nickel composite oxide (Li_{1.03}Ni_{0.82}Co_{0.05}Mn_{0.11}O₂) were mixed to prepare a mixed powder of a positive electrode active material. A mixing ratio was “large particles/small particles=6/4 (mass ratio)”. D50 of the large particles was 17 μm, and D50 of the small particles was 4 μm. A positive electrode slurry was prepared by mixing 97.6 parts by mass of the mixed powder, 1.5 parts by mass of a conductive material (carbon black), 0.9 parts by mass of a binder (PVdF), and a predetermined amount of a dispersion medium (N-methyl-2-pyrrolidone). The positive electrode slurry was applied to a surface of a positive electrode substrate (Al foil) at a coating amount of 350 (g/m²) and was dried to form a positive electrode active material layer. The positive electrode active material layer was compressed by a rolling machine. In this way, a positive electrode raw sheet in which the density of the positive electrode active material layer is 3.5 (g/cc) was manufactured. The positive electrode raw sheet was cut into a predetermined size, thereby manufacturing a positive electrode plate. A tab terminal (Al thin plate) was joined to the positive electrode plate.

### (Manufacturing of Negative Electrode Plate)

A negative electrode slurry was prepared by mixing 98 parts by mass of a negative electrode active material (natural graphite; D50=17 μm and specific surface area=1.2 m²/g), 1 part by mass of CMC, 1 part by mass of SBR, and a predetermined amount of a dispersion medium (water). The negative electrode slurry was applied to a surface of the negative electrode substrate (Cu foil) at a coating amount of 225 (g/m²) and was dried to form a negative electrode active material layer having a specific surface area S of 4 (m²/g). The negative electrode active material layer was compressed by a rolling machine. In this way, a negative electrode raw sheet in which the density of the negative electrode active material layer is 1.5 (g/cc) was manufactured. The negative electrode raw sheet was cut into a predetermined size, thereby manufacturing a negative electrode plate. A tab terminal (Ni thin plate) was joined to the negative electrode plate.

### (Assembly)

A porous sheet composed of polyolefin was prepared as a separator. The positive electrode plate, the separator, and the negative electrode plate were stacked with the separator being interposed between the positive electrode plate and the negative electrode plate. By winding them, a wound type electrode assembly was formed. As an exterior package, a pouch composed of an Al laminate film was prepared. The electrode assembly was accommodated in the exterior package.

### (Injection of Electrolyte Solution)

An electrolyte solution was prepared. The electrolyte solution included below-described components. The electrolyte solution was injected into the exterior package at an amount of 2 (g/Ah). The exterior package was sealed. In this way, a test cell was manufactured.
Solvent: EC/EMC=3/7 (volume ratio)
Supporting electrolyte: LiPF₆ (1 mol/L)
Additive: LiBOB (0.5% in mass fraction)

### (Activation)

Initial charging/discharging was performed under a temperature environment of 25° C. The test cell was charged with a current of 0.2 mA/cm² in accordance with the constant current method until the positive electrode potential reached 4.30 V (vs. Li⁺/Li). Then, the test cell was charged in accordance with the constant voltage method until the current reached 0.04 mA/cm². In this way, an initial charging capacity was measured. After 10 minute of rest, the test cell was discharged with a current of 0.2 mA/cm² in accordance with the constant current method until the positive electrode potential reached 2.5 V (vs. Li+/Li). In this way, an initial discharging capacity was measured.

### <Measurement of Capacity Retention>

The cell capacity of the test cell after the activation was measured under the following conditions in a temperature environment of 25° C. before and after the cycle test.
Constant Current (CC) Charging: CC current: 0.05 C, 4.2 V cutoff
Constant Current (CC) Discharging: CC current: 0.05 C, 3.0 V cutoff

The capacity retention is calculated in accordance with the following formula:

Capacity retention=(cell capacity after cycle test/cell capacity before cycle test)×100(%).

The cycle durability test was performed under the following conditions.
Temperature: 25° C.
Number of cycles: 100 cycles
Constant Current-Constant Voltage (CC-CV) Charging: CC current=1 C, CV voltage =4.2 V, 0.05 C cutoff
Rest: 1 minute
Constant Current (CC) Discharging: CC current=1 C, 3.0 V cutoff
Rest: 10 minutes

The capacity retention of the test cell after the below-described storage durability test (after 120 days) was measured in the same manner. Results are shown in Table 1.

### <Storage Durability Test>

The test cell after the activation was subjected to the constant current (CC) charging (current=0.05 C, 4.2 V cutoff), and was then stored in a thermostatic chamber at 60° C. for 120 days. The cell capacity before the storage durability test as well as the cell capacities on the 30th day, 60th day, 90th day, and 120th day of the days of storage were measured under the following conditions in a temperature environment of 25° C.
Constant Current (CC) Charging: CC current: 0.05 C, 4.2 V cutoff
Constant Current (CC) Discharging: CC current: 0.05 C, 3.0 V cutoff

The capacity retention is calculated in accordance with the following formula:

Capacity retention=(cell capacity at each day of storage/cell capacity before storage durability test)×100(%).

Results are shown in Table 1.

### <Specific Surface Area>

A BET specific surface area of the negative electrode plate removed from the electrode assembly after the initial charging/discharging was measured in accordance with a nitrogen adsorption method.

### <Measurement of Charging Capacity and Discharging Capacity of Single Electrode>

The test cell after the activation was charged and discharged under the following conditions in a temperature environment of 25° C.
Constant Current (CC) Charging: CC current: 0.05 C, 4.2 V cutoff
Constant Current (CC) Discharging: CC current: 0.05 C, 3.0 V cutoff

The test cell after the charging and discharging was disassembled to remove the positive electrode plate and the negative electrode plate, thereby producing a single-electrode cell (hereinafter referred to as “positive electrode cell”) with the positive electrode plate and the Li foil facing the positive electrode plate and a single-electrode cell (hereinafter referred to as “negative electrode cell”) with the negative electrode plate and the Li foil facing the negative electrode plate. The electrolyte solution was EC/EMC=3/7_LiPF6:1 mol/l.

Next, a positive electrode remaining discharging amount of the positive electrode cell was measured by the constant current (CC) discharging (CC current=0.05 C, 2.5 V cutoff), and then the positive electrode capacity was measured under the following conditions.
Constant Current (CC) Charging: CC current=0.05 C, 4.3 V cutoff
Rest: 10 minutes
Constant Current (CC) Discharging: CC current=0.05 C, 2.5 V cutoff

Then, a negative electrode remaining discharging amount of the negative electrode cell was measured by constant current (CC) charging (CC current=0.05 C, 2.0 V cutoff), and then the negative electrode capacity was measured under the following conditions.
Constant Current (CC) Discharging: CC current=0.05 C, 0.001 V cutoff
Rest: 10 minutes
Constant Current (CC) Charging: CC current=0.05 C, 2.0 V cutoff

For the test cell after the storage durability test (after 120 days), the charging capacity and discharging capacity of each single electrode were measured in the same manner.

The initial charging capacity and discharging capacity of each single electrode are shown in Table 1.

### <Li-ICP Measurement>

The test cell after the activation was charged and discharged under the following conditions in a temperature environment of 25° C.
Constant Current (CC) Charging: CC current: 0.05 C, 4.2 V cutoff
Constant Current (CC) Discharging: CC current: 0.05 C, 3.0 V cutoff

The test cell after the charging and discharging was disassembled, 10 cm² of the negative electrode plate was cut out, the negative electrode active material layer was detached in 10 ml of water, 10 ml of hydrochloric acid was added thereto, and then treatment at a temperature of 80° C. was performed for 30 minutes. A resulting aqueous solution was filtered, water was added to a deposited object on the filter paper, an adhered part thereon was also collected, and the collected aqueous solution was measured to be 100 ml. B-ICP measurement was performed and an amount of Li was found in accordance with an external calibration curve method.

The amount of Li in the test cell after the storage durability test (after 120 days) was found in the same manner.

### <Positive Electrode Shift Amount, Negative Electrode Shift Amount, Reserve Capacity, and Positive Electrode-Negative Electrode Deviation Amount>

The positive electrode shift amount (Ah/m²) is found as an amount obtained by subtracting, from the negative electrode shift amount (Ah/m²), a difference between a positive electrode-negative electrode deviation amount (Ah/m²) after the storage durability test and an initial positive electrode-negative electrode deviation amount (Ah/m²).

The negative electrode shift amount (Ah/m²) is found as an amount obtained by subtracting a difference between the initial amount of Li (Ah/m²) of the negative electrode and the negative electrode remaining discharging amount (Ah/m²) from a difference between the amount of Li (Ah/m²) of the negative electrode and the negative electrode remaining discharging amount (Ah/m²) after the storage durability test.

The reserve capacity (Ah/m²) is found as an amount obtained by subtracting the cell capacity (Ah/m²) and the negative electrode remaining discharging amount (Ah/m²) from the negative electrode discharging capacity (Ah/m²).

The positive electrode-negative electrode deviation amount (Ah/m²) is found as an amount obtained by subtracting the negative electrode remaining discharging amount (Ah/m²) from the positive electrode remaining discharging amount (Ah/m²).

### Examples 2 to 7 and Comparative Examples 1 to 5

Each of test cells was manufactured in the same manner as in Example 1 except that the composition ratio of the positive electrode active material, the type of the negative electrode active material, a ratio of components when the negative electrode active material was a mixture, the specific surface area of the negative electrode active material, and the specific surface area of the negative electrode active material layer were changed as shown in Table 1. Results are shown in Table 1.

TABLE 1

| | | Example 1 | Example 2 | Example 3 | Example 4 | Example 5 | Example 6 | Example 7 |
|---|---|---|---|---|---|---|---|---|
| x (Li/Mn 1 + x) | | 0.03 | 0.06 | 0.08 | 0.03 | 0.06 | 0.08 | 0.03 |
| Ni Ratio | | 0.82 | 0.82 | 0.82 | 0.82 | 0.82 | 0.82 | 0.82 |
| Co Ratio | | 0.05 | 0.05 | 0.05 | 0.05 | 0.05 | 0.05 | 0.05 |
| Mn Ratio | | 0.11 | 0.11 | 0.11 | 0.11 | 0.11 | 0.11 | 0.11 |
| Ti Ratio | | 0.02 | 0.02 | 0.02 | 0.02 | 0.02 | 0.02 | 0.02 |
| Type of Negative Electrode Active | | Natural | Natural | Natural | Natural | Natural | Natural | Natural |
| Material | | Graphite | Graphite | Graphite | Graphite/ | Graphite/ | Graphite/ | Graphite/ |
| | | | | | Artificial | Artificial | Artificial | Artificial |
| | | | | | Graphite | Graphite | Graphite | Graphite |
| Mixing Ratio | | 10/0 | 10/0 | 10/0 | 5/5 | 5/5 | 5/5 | 3/7 |
| (Natural Graphite/Artificial Graphite) | | | | | | | | |
| D50 (μm) of Natural Graphite | | 17 | 17 | 17 | 17 | 17 | 17 | 17 |
| D50 (μm) of Artificial Graphite | | — | — | — | 17 | 17 | 17 | 17 |
| Specific Surface Area (m²/g) of | | 2.9 | 2.9 | 2.9 | 2.1 | 2.1 | 2.1 | 1.7 |
| Negative Electrode Active Material | | | | | | | | |
| Specific Surface Area S (m²/g) of | | 4 | 4 | 4 | 3 | 3 | 3 | 2.5 |
| Negative Electrode Active Material | | | | | | | | |
| Layer | | | | | | | | |
| Initial Single- | Positive | 80 | 80 | 80 | 80 | 80 | 80 | 80 |
| Electrode Charging | Electrode | | | | | | | |
| Capacity | Negative | 85 | 85 | 85 | 85 | 85 | 85 | 85 |
| (Ah/m²) | Electrode | | | | | | | |
| Initial Single- | Positive | 73.6 | 73.6 | 73.6 | 73.6 | 73.6 | 73.6 | 73.6 |
| Electrode | Electrode | | | | | | | |
| Discharging | Negative | 78.2 | 78.2 | 78.2 | 78.2 | 78.2 | 78.2 | 78.2 |
| Capacity | Electrode | | | | | | | |
| (Ah/m²) | | | | | | | | |
| Cell Capacity (Ah/m²) | | 72 | 72 | 72 | 73.6 | 73.6 | 73.6 | 73.6 |
| Capacity Retention | 30th Day | 97 | 97 | 98 | 99 | 99 | 99 | 99 |
| (%) | 60th Day | 96 | 96 | 97 | 98 | 98 | 98 | 98 |
| | 90th Day | 95 | 96 | 96 | 97 | 97 | 98 | 98 |
| | 120th Day | 94 | 95 | 95 | 96 | 97 | 97 | 97 |
| Cycle Capacity | Initial | 95 | 95 | 95 | 95 | 95 | 95 | 95 |
| Retention (%) | After Storage | 95 | 95 | 95 | 95 | 95 | 95 | 95 |
| | Durability Test | | | | | | | |

| | | Comparative | Comparative | Comparative | Comparative | Comparative |
|---|---|---|---|---|---|---|
| | | Example 1 | Example 2 | Example 3 | Example 4 | Example 5 |
| x (Li/Mn 1 + x) | | 0.06 | 0.08 | 0.03 | 0.06 | 0.08 |
| Ni Ratio | | 0.82 | 0.82 | 0.82 | 0.82 | 0.82 |
| Co Ratio | | 0.05 | 0.05 | 0.05 | 0.05 | 0.05 |
| Mn Ratio | | 0.11 | 0.11 | 0.11 | 0.11 | 0.11 |
| Ti Ratio | | 0.02 | 0.02 | 0.02 | 0.02 | 0.02 |
| Type of Negative Electrode Active | | Natural | Natural | Artificial | Artificial | Artificial |
| Material | | Graphite/ | Graphite/ | Graphite | Graphite | Graphite |
| | | Artificial | Artificial | | | |
| | | Graphite | Graphite | | | |
| Mixing Ratio | | 3/7 | 3/7 | 0/10 | 0/10 | 0/10 |
| (Natural Graphite/Artificial Graphite) | | | | | | |
| D50 (μm) of Natural Graphite | | 17 | 17 | — | — | — |
| D50 (μm) of Artificial Graphite | | 17 | 17 | 17 | 17 | 17 |
| Specific Surface Area (m²/g) of | | 1.7 | 1.7 | 1.2 | 1.2 | 1.2 |
| Negative Electrode Active Material | | | | | | |
| Specific Surface Area S (m²/g) of | | 2.5 | 2.5 | 2 | 2 | 2 |
| Negative Electrode Active Material | | | | | | |
| Layer | | | | | | |
| Initial Single- | Positive | 80 | 80 | 80 | 80 | 80 |
| Electrode Charging | Electrode | | | | | |
| Capacity | Negative | 85 | 85 | 85 | 85 | 85 |
| (Ah/m²) | Electrode | | | | | |
| Initial Single- | Positive | 73.6 | 73.6 | 73.6 | 73.6 | 73.6 |
| Electrode | Electrode | | | | | |
| Discharging | Negative | 78.2 | 78.2 | 78.2 | 78.2 | 78.2 |
| Capacity | Electrode | | | | | |
| (Ah/m²) | | | | | | |
| Cell Capacity (Ah/m²) | | 73.6 | 73.6 | 73.6 | 73.6 | 73.6 |
| Capacity Retention | 30th Day | 99 | 99 | 99 | 99 | 99 |
| (%) | 60th Day | 99 | 99 | 99 | 99 | 99 |
| | 90th Day | 98 | 99 | 98 | 99 | 99 |
| | 120th Day | 98 | 98 | 98 | 99 | 99 |
| Cycle Capacity | Initial | 95 | 95 | 80 | 80 | 80 |
| Retention (%) | After Storage | 92 | 90 | 70 | 63 | 60 |
| | Durability Test | | | | | |

In each of Examples 1 to 7 according to the present disclosure, the initial cycle capacity retention was 95% or more, and the cycle capacity retention was 95% or more even after the storage durability test. Further, in each of Examples 2 to 7, the capacity retention after the storage durability test was 95% or more. On the other hand, in each of Comparative Examples 1 and 2, the initial cycle capacity retention was 95% or more, but the cycle capacity retention was decreased after the storage durability test. Further, in each of Comparative Examples 3 to 5, the initial cycle capacity retention was low, and the cycle capacity retention was decreased after the storage durability test.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A non-aqueous electrolyte secondary battery comprising an electrode assembly, wherein
the electrode assembly includes a positive electrode plate and a negative electrode plate,
the positive electrode plate includes a positive electrode active material layer,
the negative electrode plate includes a negative electrode active material layer,
the positive electrode active material layer includes a positive electrode active material represented by the following formula (1):
Li₍₁₊ₓ₎Ni_{y}Ti_{z}Me_{(1-y-z)}O₂, where
Me includes two or more selected from a group consisting of Mn, Co and Al, and
relations of 0<x<0.1, 0.8<y<0.85 and 0≤z<0.03 are satisfied,
the negative electrode active material layer includes an negative electrode active material,
the negative electrode active material includes graphite, and
when a specific surface area of the negative electrode active material layer is represented by S (m²/g), the following relational formula is satisfied:
$$10 x + 2 < S . \qquad ( a )$$

2. The non-aqueous electrolyte secondary battery according to claim 1, wherein (b) S<10x+3.4 is further satisfied.

3. The non-aqueous electrolyte secondary battery according to claim 1, wherein a graphite content in the negative electrode active material is 99 mass % or more.

4. The non-aqueous electrolyte secondary battery according to claim 1, wherein a relation of 0.01<z<0.03 is satisfied in the formula (1).
